(19) United States
(12) Patent Application Publication
(10) Pub. No.: US 2026/0295609 A1
(43) Pub. Date: Oct. 1, 2026

(54) Irrigation Device With Rotating Deflector

(71) Applicant: Rain Bird Corporation, Azusa, CA (US)

(72) Inventors: Craig David Carroll, Costa Mesa, CA (US); Randall Dennis Bousfield, Tucson, AZ (US); Michael A. McAfee, Tucson, AZ (US); Jiangjiang Dai, Tucson, AZ (US); Matthew S. Prucinsky, Tucson, AZ (US); Brian C. Hoover, Tucson, AZ (US)

(21) Appl. No.: 19/091,367

(22) Filed: Mar. 26, 2025

(51) Int. Cl. B05B 3/06; A01G 25/02

(52) U.S. Cl. CPC B05B 3/063; A01G 25/02

(57) ABSTRACT

An irrigation device is provided having a rotatable deflector with features that control the speed of rotation. The irrigation device has a base with a fluid inlet, a flow passage from the inlet and a divider positioned to separate fluid through the flow passage into a first flow and a second flow. A frame engages and extends across the base. The deflector has a first side supported by the base, an opposite second side supported by the frame, a first flow channel positioned to receive the first flow to form a first fluid stream oriented to generate a first rotational force, and a second flow channel positioned to receive the second flow to form a second fluid stream. The second flow channel can be configured to reduce the rotational speed generated by the first flow channel. The irrigation device may move between an operational position and a non-operational position.

### FIELD

This disclosure relates generally to irrigation devices and, more particularly, to irrigation devices with spinning assemblies.

### BACKGROUND

Irrigation devices are often used to irrigate a desired area about the device. Different devices may be used in different irrigation areas to accommodate different criteria. In the agricultural area, spinner irrigation devices, in which a deflector rotates at a high rate of speed, may be used because they can provide relatively uniform water distribution at a relatively low pressure, which is desirable for irrigating plants. Further, spinner irrigation devices may also be made with a few relatively low-cost components.

In the agricultural area, there is a need for low-cost spinning irrigation devices that water a large area with high reliability. The spinning motion, however, may cause friction and wear between the spinning components and the non-spinning components of the sprinkler. Over time, this wear can reduce the life of the spinner and can cause it to stop functioning. Thus, it is desirable to provide a robust design that reduces the friction between spinning and non-spinning components to prolong the life of spinners. Further, it is desirable to provide uniform irrigation coverage by the spinner.

### BRIEF DESCRIPTION OF THE DRAWINGS

FIG. 1 is a perspective view of a first embodiment of a dual stream spinner assembly embodying features of the present disclosure;

FIG. 2A is a front elevational view of the dual stream spinner assembly of FIG. 1 with a deflector in a raised, operational position

FIG. 2B is a front elevational view of the dual stream spinner assembly of FIG. 1 with the deflector in a lowered, non-operational position;

FIG. 3 is a side elevational view of the dual stream spinner assembly of FIG. 1 with the deflector in the raised, operational position;

FIG. 4A is a cross-sectional view of the dual stream spinner assembly of FIG. 1 with the deflector in the raised, operational position;

FIG. 4B is a cross-sectional view of the dual stream spinner assembly of FIG. 1 with the deflector in the lowered, non-operational position;

FIG. 4C is a cross-sectional view of a first alternative dual stream spinner assembly with the deflector in the raised, operational position;

FIG. 4D is a cross-sectional view of a second alternative dual stream spinner assembly with the deflector in the raised, operational position;

FIG. 4E is a cross-sectional view of a third alternative dual stream spinner assembly with the deflector in the raised, operational position;

FIG. 5 is a top exploded view of the dual stream spinner assembly of FIG. 1;

FIG. 6 is a bottom exploded view of the dual stream spinner assembly of FIG. 1;

FIG. 7 is a front elevational view of the frame of the dual stream spinner assembly of FIG. 1;

FIG. 8A is a bottom view of the frame of the dual stream spinner assembly of FIG. 1;

FIG. 8B is a cross-sectional view of the frame of the dual stream spinner assembly of FIG. 1 as viewed from the top of the frame;

FIG. 8C is a cross-sectional view of an alternative frame of the dual stream spinner assembly of FIG. 1 as viewed from the top of the frame with angled struts;

FIG. 9 is a front elevational view of the nozzle of the dual stream spinner assembly of FIG. 1;

FIG. 10 is a bottom view of the nozzle of the dual stream spinner assembly of FIG. 1;

FIG. 11 is a top perspective view of the deflector of the dual stream spinner assembly of FIG. 1;

FIG. 12 is a bottom perspective view of the deflector of the dual stream spinner assembly of FIG. 1;

FIG. 13 is a bottom view of the deflector of the dual stream spinner assembly of FIG.

FIG. 14 is a bottom view of the deflector of the dual stream spinner assembly of FIG. showing exit angles;

FIG. 15 is a cross-sectional view of the dual stream spinner assembly of FIG. 1 with ceramic material at the bottom of the deflector;

FIG. 16 is a front elevational view of a second embodiment of a dual stream spinner assembly embodying features of the present disclosure;

FIG. 17 is a cross-sectional view of the dual stream spinner assembly of FIG. 14;

FIG. 18 is a bottom view of the deflector of the dual stream spinner assembly of FIG. 14; and

FIG. 19 is a bottom perspective view of the deflector of the dual stream spinner assembly of FIG. 14.

### DESCRIPTION OF THE PREFERRED EMBODIMENTS

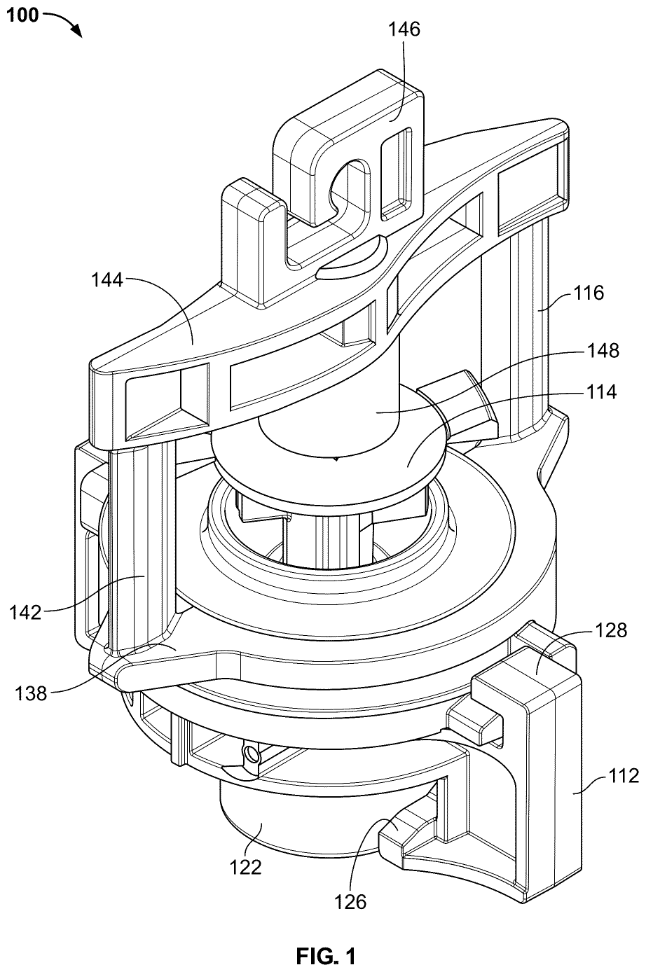

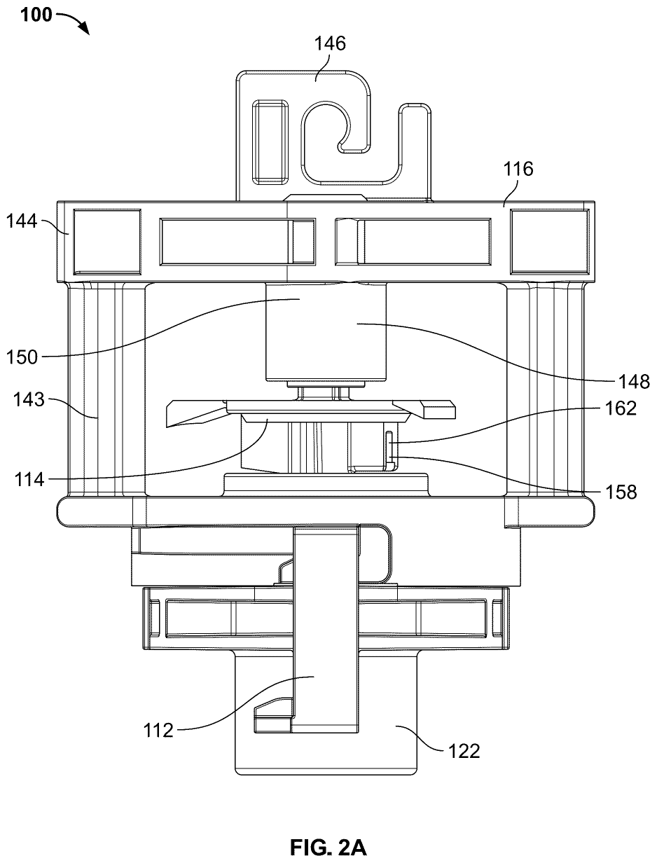

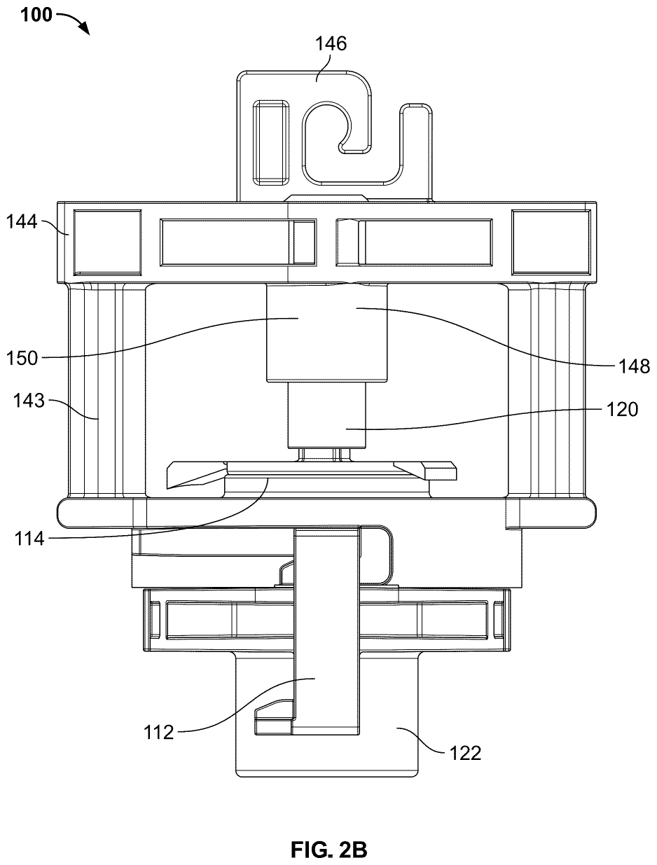

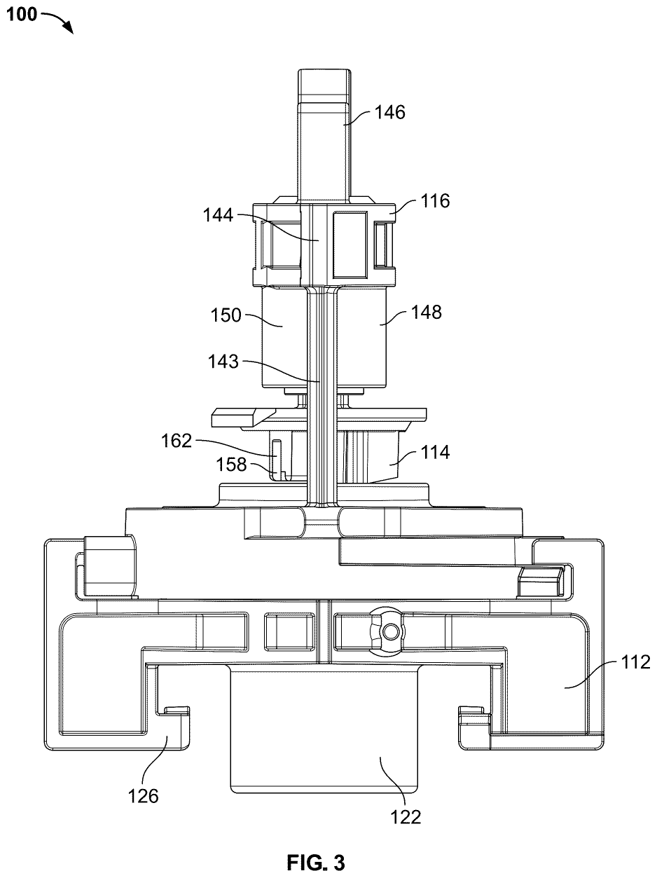

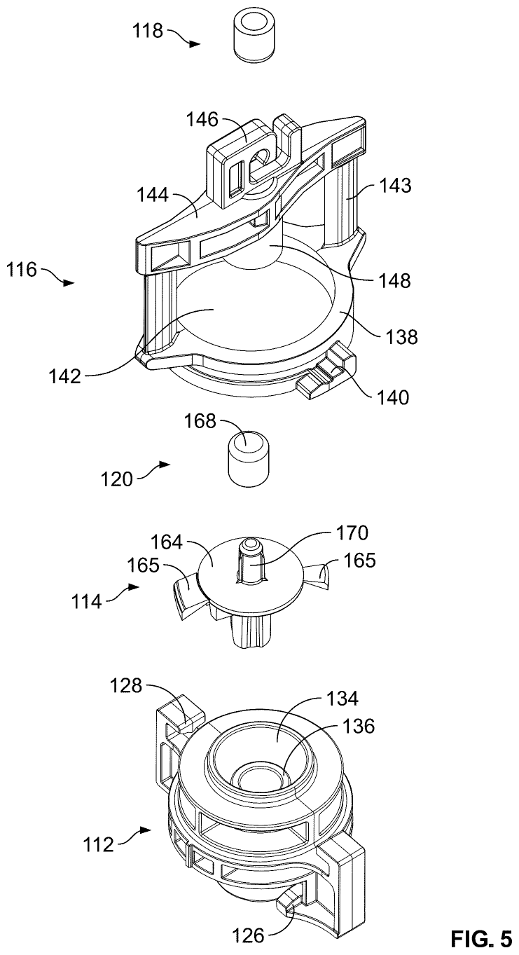

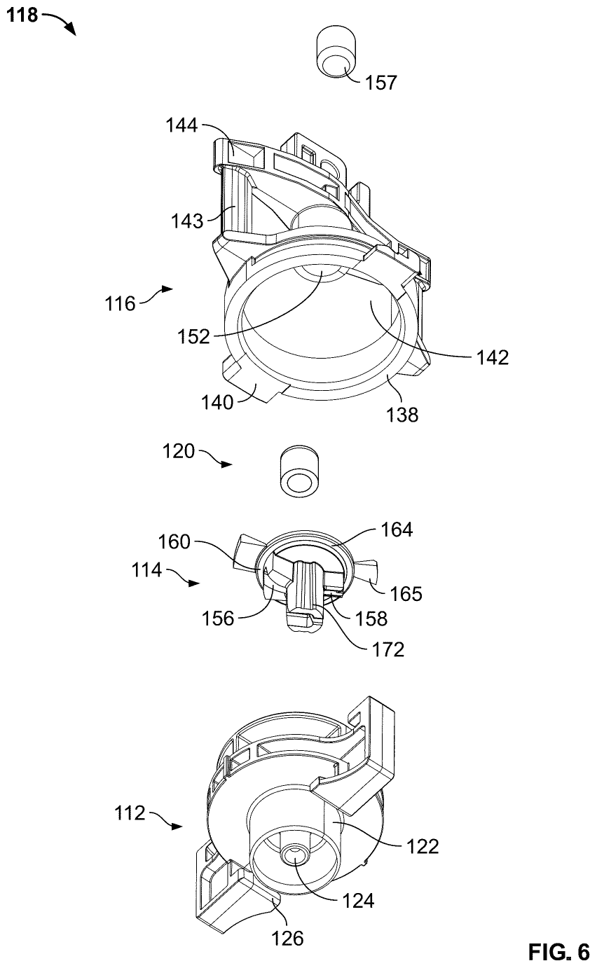

With respect to FIGS. 1-6, a dual stream spinner assembly 100 (or a micro-sprinkler or micro-spray device) is shown. In the agriculture industry, these types of irrigation devices provide growers with an efficient irrigation solution. These types of irrigation devices include deflectors that rotate at high speeds with estimates that some deflectors may rotate on the order of about 60 revolutions per second. The assembly 100 may include a snap-fit feature of the components that helps to ensure the consistent alignment of the various components. As addressed further below, dual stream spinner assembly 100 utilizes a deflector with two flow channels (or flutes) to accommodate two fluid streams. In one form, the flow channels may be arranged with exit angles such that the fluid streams cause opposing rotational forces so as to reduce the rotational speed of the deflector. Although this irrigation device is described in the context of micro-sprinklers and the agricultural setting, the teachings herein may be applied to other types of irrigation devices and settings.

As can be seen in FIGS. 1-6, the dual stream spinner assembly 100 includes various components. In this exemplary form, the dual stream spinner assembly 100 preferably includes a nozzle 112, a deflector 114, a frame 116, and two ceramic bodies 118 and 120. Some of these components, such as, for example, nozzle 112, deflector 114, and/or frame 116, may be conveniently and economically formed as plastic molded components. Further, it is also contemplated that some of these components may be combined to form a unitary component or structure. In this disclosure, the terms “top” and “bottom” are used for ease of understanding, but it should be understood that they refer more generally to two sides of a body, e.g., nozzle, deflector, frame, etc.

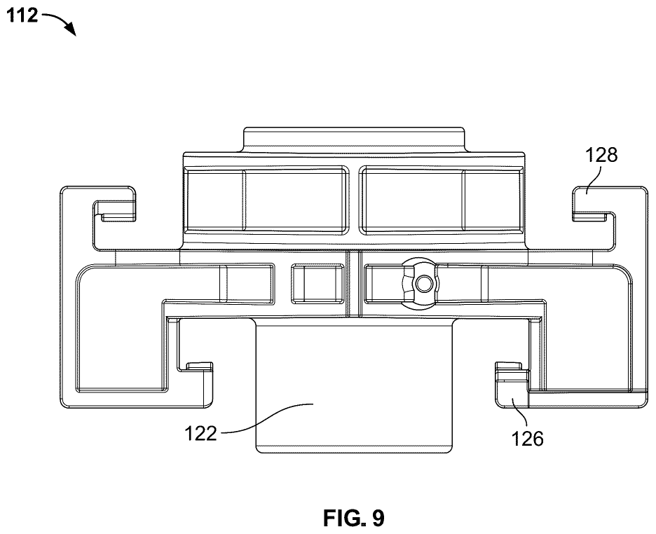

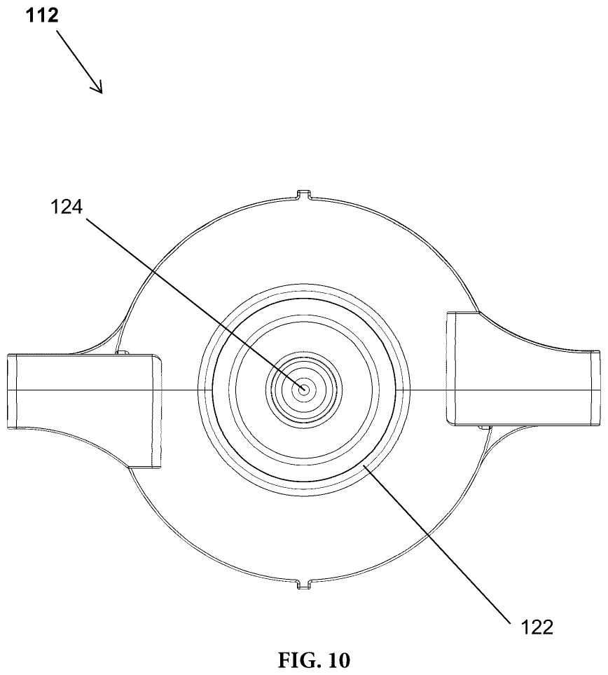

As shown in FIGS. 9 and 10, the nozzle 112 (which also constitutes a base of the spinner assembly 100) preferably includes a lower adapter portion 122 that is intended for mounting to a connection at a water (or fluid) source. The adapter portion 122 may be cylindrical in shape and may include an inlet 124 for fluidly coupling to, and receiving fluid from, the fluid source. The nozzle 112 may also include two mounting members 126 for use when installing the dual stream spinner assembly 100. These mounting members 126 may be of any suitable form for mounting to a fluid source, and in one form, it is contemplated that the mounting members 126 are configured for a bayonet connection to the fluid source.

In one preferred form, the nozzle 112 may also include two mounting flanges 128 for engagement, such as, for example, a bayonet connection, with corresponding structure of the frame 116 to hold the nozzle 112 and the frame 116 fixed relative to one another (and to maintain alignment). The dual stream spinner assembly 100 may also optionally include a screen or filter (not shown) upstream of the inlet 124, which is intended to limit the entry of particulate matter from the fluid source that might tend to clog the nozzle 112. As should be understood, any of various types and sizes of screens may be used.

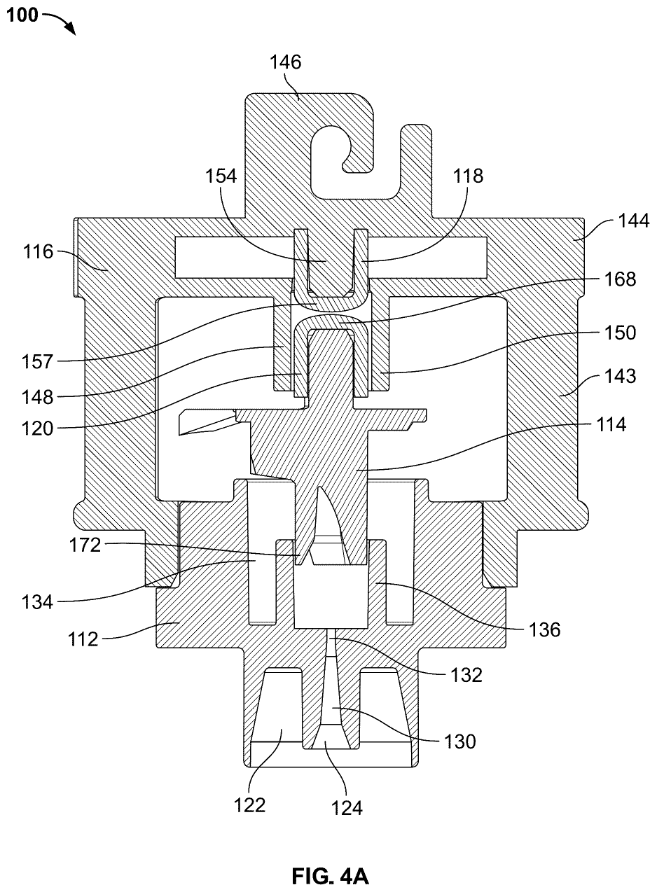

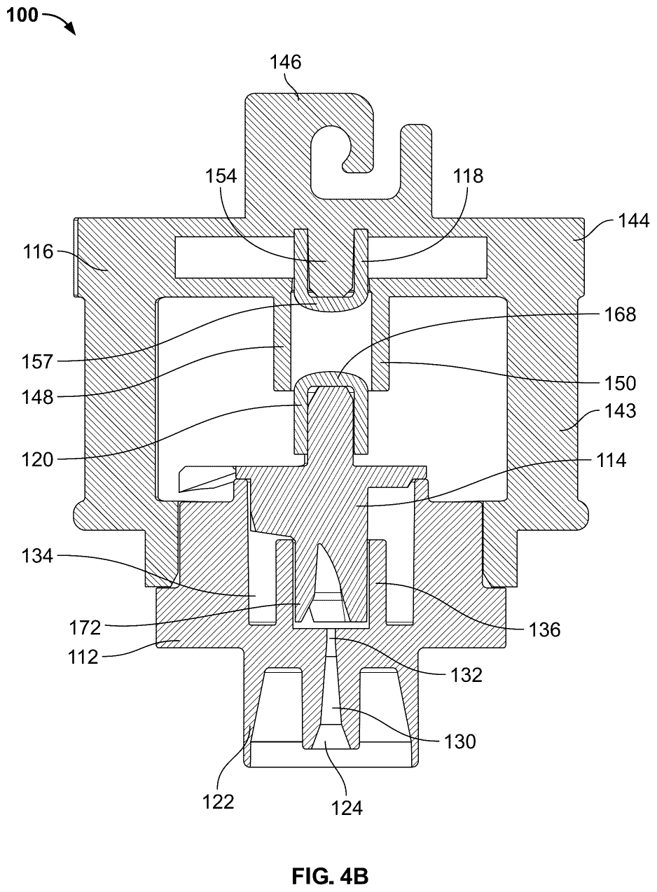

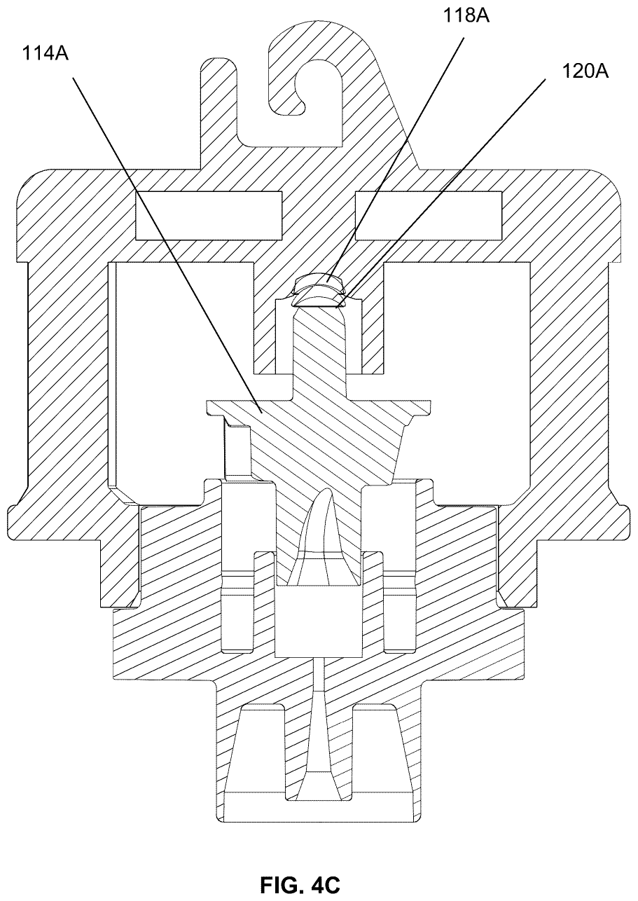

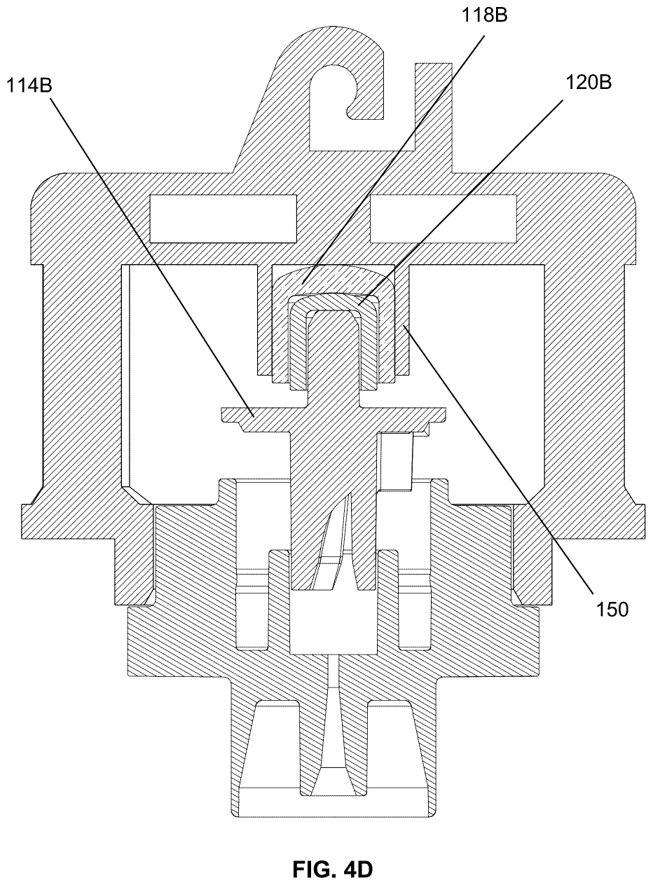

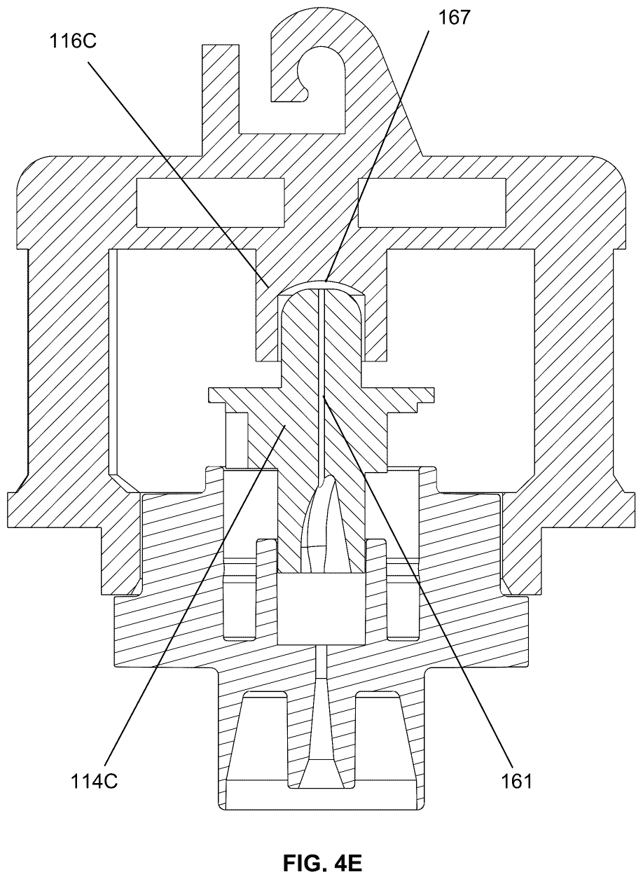

As can be seen in FIG. 4A, the nozzle 112 includes the fluid inlet 124, which receives fluid from the fluid source, and includes a flow passage 130. The flow passage 130 tapers as one proceeds upwardly from the bottom of the nozzle 112 (at the inlet 124) to an exit orifice (or outlet) 132 of the nozzle 112. The top portion of the nozzle 112 may be cylindrical in shape and may define a cylindrical recess 134 with an annular portion 136 disposed in the recess 134. As explained further below, in one form, this annular portion 136 engages and cooperates with the deflector 114 as the deflector 114 moves between operational and non-operational positions. More specifically, in one form, the annular portion 136 may engage a portion of an end of the deflector 114 in the operational position and may then act as a seat for receiving the end of the deflector 114 in the non-operational position.

As should be understood, the nozzle 112 is an example of a nozzle that may be used in the dual stream spinner assembly 100. It is generally contemplated that other sizes, types, and forms of nozzles may also be used that receive fluid and direct it upwardly against the deflector 114. For example, it may be desirable to interchange nozzles to alter the flow rate or throw radius of the dual stream spinner assembly 100 or to alter other fluid distribution characteristics.

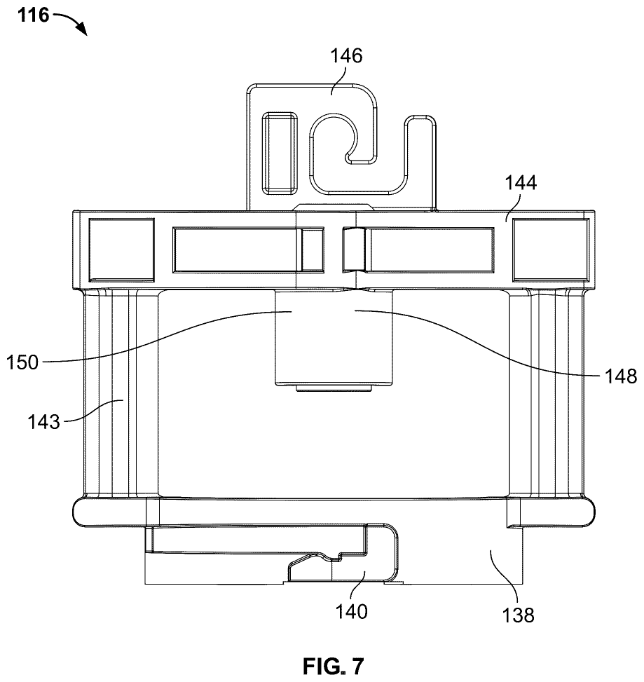

As can be seen in FIGS. 1-8, the dual stream spinner assembly 100 also includes a frame 116. The frame 116 generally engages and helps maintain the alignment of the components of the dual stream spinner assembly 100. More specifically, it helps maintain the desired alignment of the nozzle 112, deflector 114, and the ceramic bodies 118 and 120.

The frame 116 preferably includes a lower cylindrical portion 138 with two mounts 140 on either side for engagement with the corresponding mounting flanges 128 of nozzle 112. In this form, it is contemplated that the mounting flanges 128 are flexible so to move to allow the mounts 140 to slide into a locking engagement with the flanges 128. Other types of connectors or engagement members may also be used to fasten and align the frame 116 to the nozzle 112. The lower cylindrical portion 138 also defines an opening 142 for receipt of the top portion of the nozzle 112.

In one form, the lower cylindrical portion 138 is connected by two struts 143 to an upper portion 144, which, in turn, extends between the two struts 143. The upper portion 144 may engage, or extend into, a clip 146 or other feature for mounting the dual stream spinner assembly 100, such as, for example, hanging the dual stream spinner assembly 100 from a wire in an orchard via the clip 146. In this form, the clip 146 is preferably cane-shaped and allows a wire to be inserted into the clip 146 from the top for mounting the dual stream spinner assembly 100 to the wire.

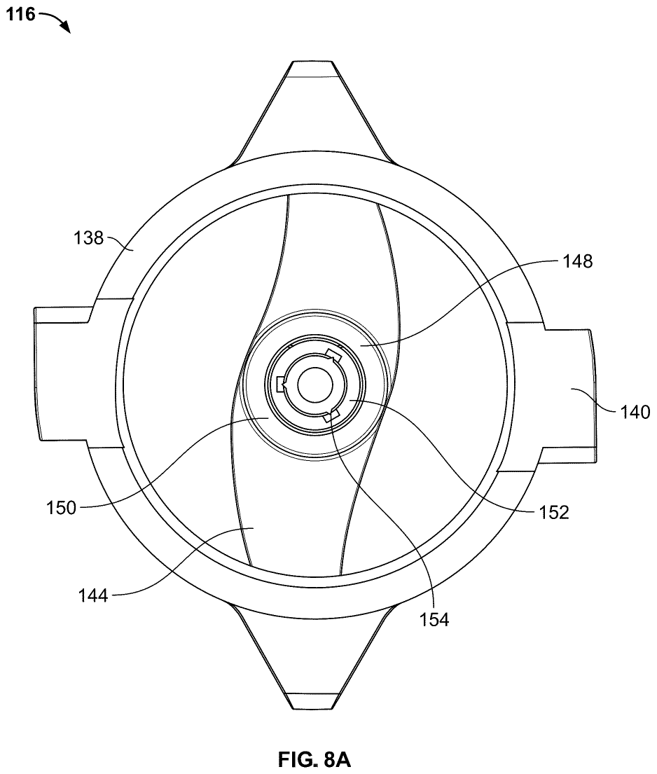

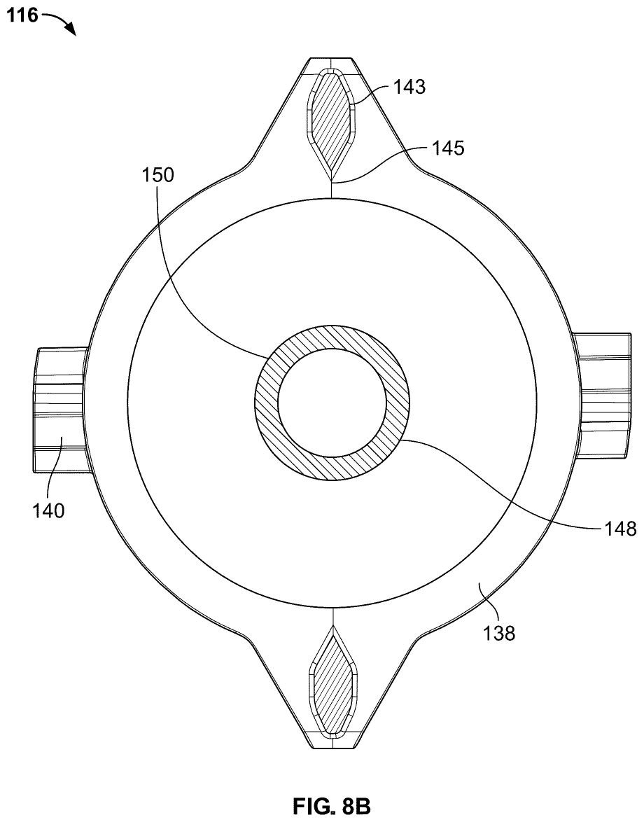

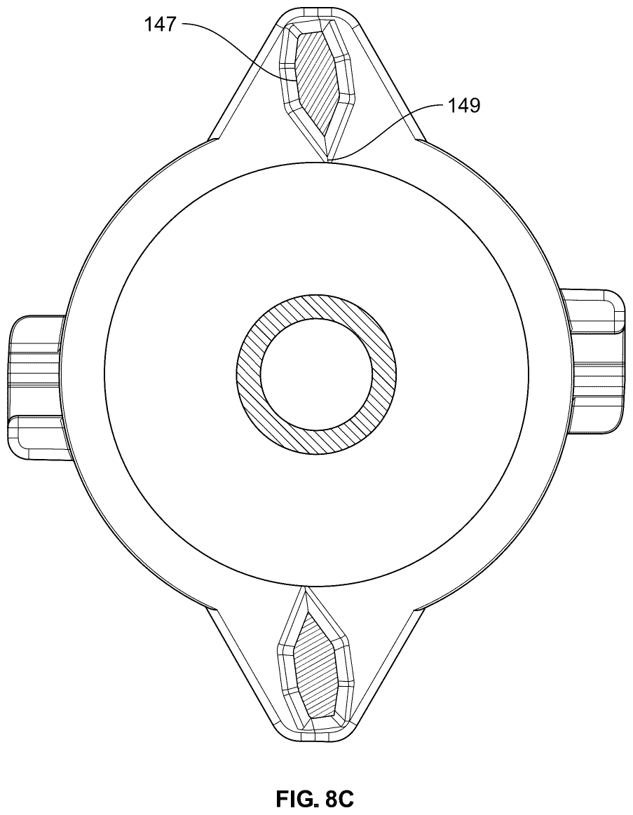

In one form, as can be seen from FIG. 8B, the two struts 143 may be oriented so that a radially inner apex 145 of each strut 143 is directed toward, and aligned with, the axis of deflector rotation. The two struts 143 are disposed in a path of fluid exiting the deflector as the deflector rotates. In this form, each strut 143 may be generally symmetric about a vertical plane drawn through the apex 145 with the vertical plane intersecting the axis of deflector rotation. In this form, the apex is pointed toward the axis of deflector rotation.

However, in other forms, such as shown, for example, in FIG. 8C, it is contemplated that each strut 147 may be not aligned with and angled relative to the axis of deflector rotation. In this alternative form, the apex 149 is pointed in a direction at an angle relative to the axis of deflector rotation. Each strut 147 may be rotated, relative to the orientation of FIG. 8B, so that the bisecting vertical plane drawn through the apex 149 will not intersect the axis of deflector rotation. In one form, for example, the strut 147 may be rotated about 8-9 degrees relative to the orientation shown in FIG. 8B. In this alternative form, it is preferred that the angle and rotation of the strut 147 be in a direction opposite the rotation of the deflector. It is contemplated that these angled struts 147 may reduce stream break-up caused by fluid streams impacting the struts 147 and may result in more uniform water distribution. The strut may be angled such as the strut shown in U.S. Pat. No. 5,377,914, issued Jan. 3, 1995, which is incorporated by reference herein in its entirety. It is also contemplated that struts having a different shape than those shown in FIGS. 8B and 8C may be used.

In one form, the upper portion 144 may also engage, or extend into, a cylindrical interface 148. The cylindrical interface 148 may be disposed on an underside of the upper portion 144, which may be in the form of a cylindrical sidewall 150 defining a recess 152 opening downwards. The cylindrical interface 148 also includes a cylindrical protrusion 154 extending downwards from the underside of the upper portion 144 into the cylindrical interface 148. The cylindrical interface 148 is positioned to be aligned with the deflector 114 such that the recess 152 receives an end of the deflector 114 in the operational position, as described further below. The specific structure of the frame 116 may be modified, as desired, as long as it generally maintains the engagement and alignment of the various components of the dual stream spinner assembly 100.

In one form, a ceramic body 118 with a ceramic engagement portion 157 is mounted to the frame 116. In one form, the body 118 is a ceramic cap that is mounted over the cylindrical protrusion 154 of the frame 116. In some forms, the ceramic body 118 may be composed entirely of a ceramic material. In other forms, only the bottom portion (which engages another component during rotation of the deflector 114, as described below) is composed of a ceramic material. Ceramic material is preferably used because it has been found that ceramic material causes little friction upon rotational engagement with another component. It has been found that the ceramic material may self-polish itself during rotational engagement, leading to a more frictionless interface over time. This low friction engagement results in less wear on the components and longer life of the dual stream spinner assembly 100.

As shown in FIGS. 1-6 and 11-13, the dual stream spinner assembly 100 utilizes a deflector 114 that is disposed between the nozzle 112 and the frame 116. As can be seen, the deflector 114 is disposed downstream of the nozzle 112. As addressed further below, the deflector 114 moves between a non-operational position and an operational position in response to fluid impacting the deflector 114. In the operational position, the frame 116 engages and receives a portion of the deflector 114. The fluid causes rotation of the deflector in the operational position, and fluid impacting the deflector 114 is redirected outwardly from the deflector 114. In the non-operational position, the deflector 114 seats on the nozzle 112.

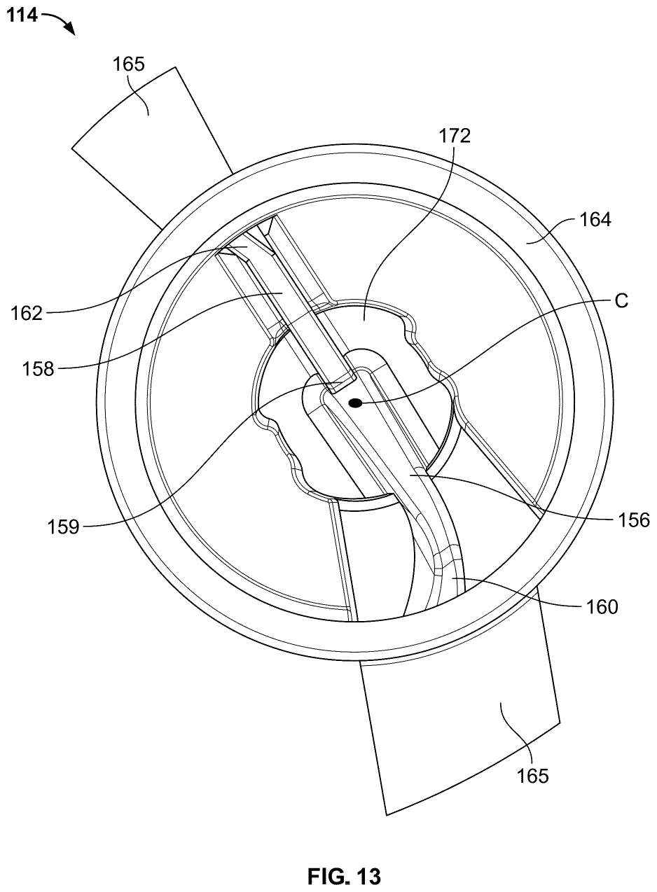

In one form, as can be seen in FIG. 13, the deflector 114 includes two asymmetric flow channels (or flutes) 156 and 158. The nozzle 112 is oriented to direct fluid to the first and second flow channels 156 and 158 such that fluid causes rotation of the deflector 114 in the operational position. The deflector 114 includes a first flow channel 156 for a first fluid stream with a first exit 160 oriented to cause a first rotational force resulting in rotation of the deflector 114. It also includes a second flow channel 158 for a second fluid stream with a second exit 162 oriented to cause a second rotational force that opposes the first rotational force resulting from the first fluid stream.

In operation, a flow path extends from the fluid inlet 124 through the flow passage 130. Further, a divider wall 159 along the flow path separates flow into a first flow and a second flow. The first flow channel 156 is positioned to receive the first flow to form the first fluid stream and is oriented to generate the first rotational force, and the second flow channel 158 is positioned to receive the second flow to form the second fluid stream. The deflector 114 continuously rotates when subjected to fluid from the fluid source.

In one form, the first and second exits 160 and 162 are oriented such that the first and second fluid streams exiting the deflector 114 cause opposing rotational forces on the deflector 114. In FIG. 13, the first and second exits 160 and 162 extend to the same side (e.g., to the left in the figure) such that the discharge of the first and second fluid streams will generate opposing rotational forces on the deflector 114. In one form, the first and second flow channels 156 and 158 are separated by the divider wall 159, and the first and second exits 160 and 162 are disposed about (but less than) 180 degrees from one another.

In one form, the cross-section of one flow channel is larger than the cross-section of the other flow channel to allow rotation. For example, the cross-section of the first flow channel 156 may be greater than the cross-section of the second flow channel 158. As a result, the rotational force resulting from the first fluid stream exiting the deflector 114 may be greater than the rotational force resulting from the second fluid stream exiting the deflector 114. This disparity in fluid streams results in the deflector 114 rotating in accordance with the rotational force resulting from the first fluid stream but at a reduced speed resulting from the counter-rotational force resulting from the second fluid stream. This reduced speed results in less friction and, over time, results in less wear on components (and a longer life for the dual stream spinner assembly 100).

It is generally contemplated that the first and second exit angles are selected to oppose each other and cause opposing rotational forces on the deflector 114. The exit angle is measured relative to a radial line from the central axis of the deflector 114 to the exit, as addressed below. In some forms, the first and second exit angles may be selected to be unequal, e.g., of different angular magnitudes, which may have an effect on the opposing rotational forces.

In one form, it is contemplated that the second (or secondary) flow channel 158 may help control rotational speed by diverting some fluid such that the diverted fluid does not support the rotational direction of the deflector 114. In one form, the diverted fluid in the second flow channel 158 may be neutral regarding generation of a rotational force affecting the rotational force of the first flow channel 156. On its own, without the rotational force of the first flow channel 156, the second flow channel 158 would not cause rotation of the deflector 114. In this regard, in some forms, it is contemplated that the second flow channel 158 may extend radially and linearly outwardly without a deviation at the exit of the second flow channel 158. In other words, it is contemplated that, in some forms, the second exit angle may be 0 degrees or about 0 degrees.

As shown in FIG. 13, the center of the divider wall 159 is offset from the central axis C of the deflector 114. It is generally contemplated that the primary flow side (or first flow channel 156) will have a larger entrance area, or inlet, to handle a larger volume or flow of water. In one form, it is contemplated that about 80% of the fluid is directed to the first (or primary) flow channel 156 and 20% of the fluid is directed to the second (secondary) flow channel 158. More of the flow into the deflector 114 goes to the first flow channel 156 than to the second flow channel 158, and the deflector 114 achieves this larger entrance area for the first flow channel 156 by offsetting the divider wall 159 in the general direction of the second exit 162. As a result, in this form, the entrance area, or inlet, to the first flow channel 156 has a larger cross-section than the entrance area or inlet, to the second flow channel 158. The divider wall 159 may be disposed in different locations relative to the center axis C to change the relative allocation of water between the two channels 156 and 158. The positioning of the divider will reduce the speed of rotation of the deflector when combined with, for example, a second flow channel that has a neutral effect on rotation.

Further, it is generally contemplated that the first flow channel 156 has a greater width than the second flow channel 158, and in some forms, the width of the first flow channel 156 may be about twice that of the second flow channel 158. It is estimated that this design may result in about a 20% reduction in rotational speed relative to a deflector without a secondary flow channel 158. It is contemplated that this rotational speed may be adjusted further by selecting a different proportion of cross-sectional area of the second flow channel 158 relative to that of the first flow channel 156.

The general curvature of the two flow channels 156 and 158 may be selected for the desired fluid distribution characteristics, such as throw distance and irrigation coverage. In one form, for the primary/first flow channel 156, it may be desirable to have a curved flow channel to avoid reducing fluid velocity to achieve a long throw distance. The first flow channel provides the most distant fluid distribution. For the secondary/second flow channel 158, this long throw distance may be less of a concern so it may be desirable to have a straighter flow channel. It should be understood, however, that either flow channel 156 or 158 may have any desired amount of curvature, as may be appropriate for certain circumstances.

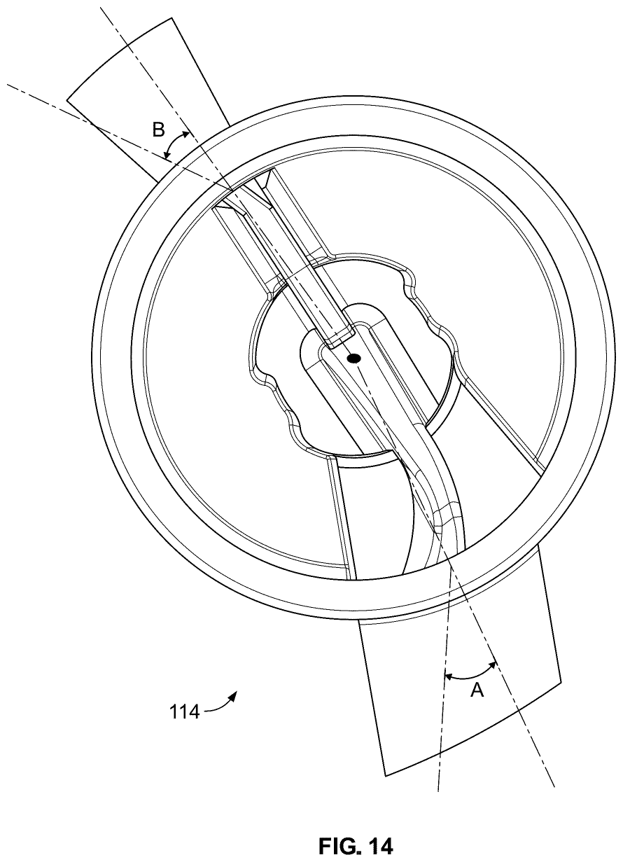

In FIG. 14, a bottom view of the deflector 114 is shown with exit angles A and B of the first and second flow channels 156 and 158, respectively. The exit angles A and B are the direction of fluid at the exit of the flow channels 156 and 158 in a plane defined by deflector plate 164 relative to a radial line from the central axis C of the deflector 114 to each exit. As illustrated, the exit angles A and B may be in opposite direction such that the channel with exit angle B counters the rotation provided by angle A. Thus, the overall rotation provided by exit angle A is slowed. In some forms, it has been found that an exit angle in the range of about 25-30 degrees for the first flow channel 156 and in the range of about 30-35 degrees for the second flow channel 158 may be desirable to balance rotational speed and maximum throw distance. In this form, the exit angles may be of different magnitudes and the exit angle of the second flow channel 158 may be greater than the exit angle of the first flow channel 156. However, it is also contemplated that other exit angles may also be used. Further, in some forms, the exit angles A and B may be the same magnitude.

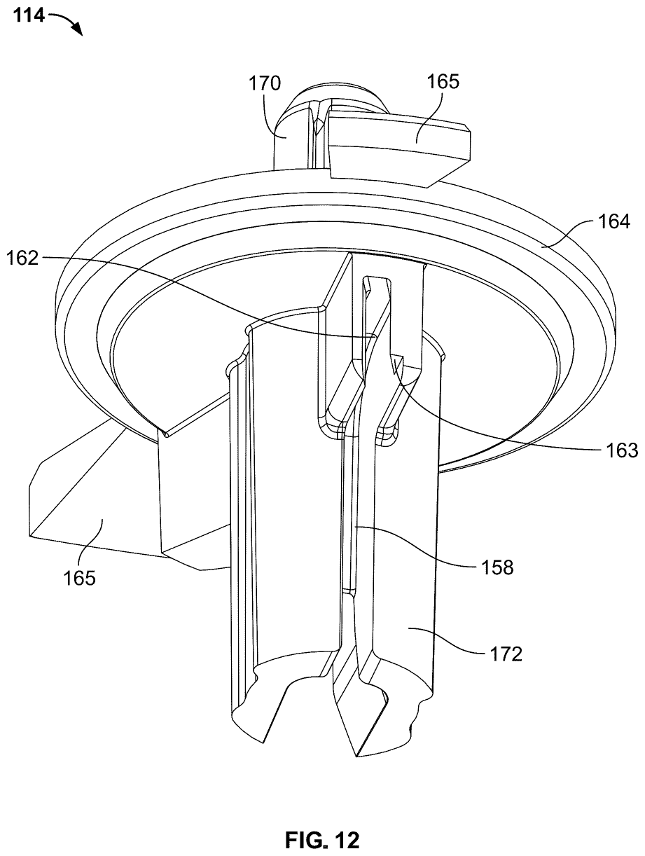

In one form, it is also contemplated that the first and second flow channels 156 and 158 may be configured so that their respective fluid streams may have different trajectories. These different trajectories may allow for more uniform coverage of surrounding terrain. Further, the second flow channel may help with more uniform distribution about the deflector 114 by not throwing as far and by providing close-in lower velocity fluid distribution. Also, features at the end of one or both flow channels 156 and 158 may result in more uniform fluid distribution. For example, as shown in FIG. 12, the second flow channel 158 includes an angled wall or wedge 163 at the second exit 162 extending laterally inwardly from the wall of the flow channel 158 towards the middle of the flow channel 158. The wedge 163 defines the exit angle of the second flow channel 158. It may also break up the exiting fluid stream and result in more uniform fluid distribution near the deflector 114.

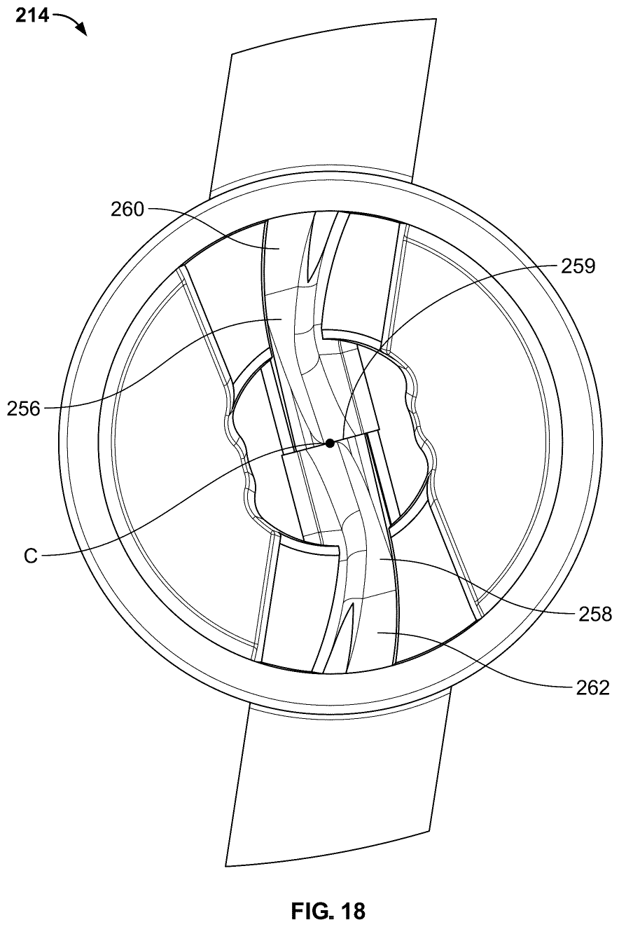

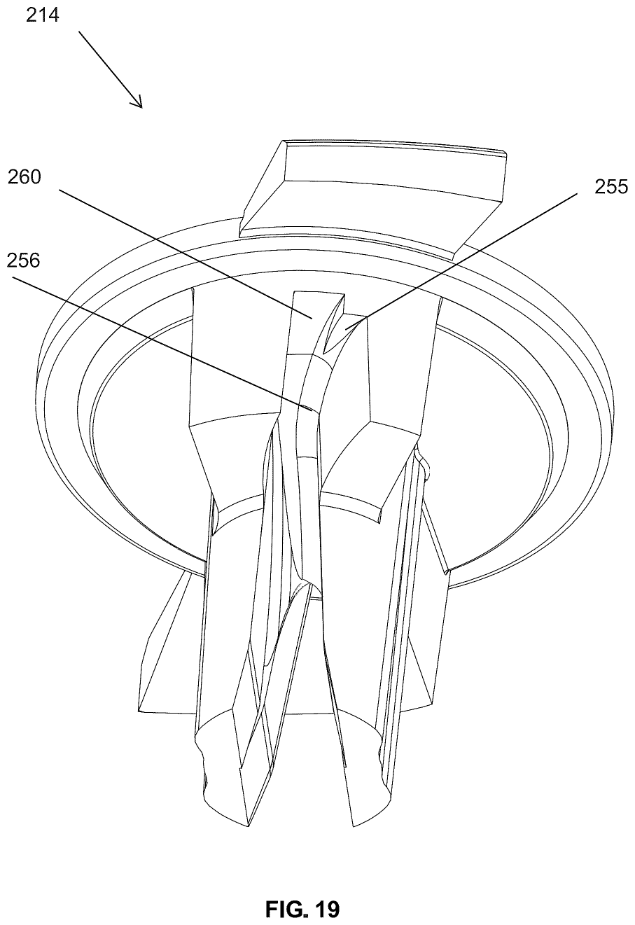

In addition, in one form, one or both flow channels 156 and 158 may each provide for different trajectories of its respective fluid stream within the flow channel itself. For example, the second flow channel 158 may include a ramp at the second exit 162 that creates a different channel depth and a different trajectory for part of the second fluid stream. In one form, a feature at the end of an exit may be extended within the channel to define a different channel depth, thereby resulting in a different trajectory. Thus, in some forms, one or both of the flow channels 156 and 158 may have two different channel depths at their respective exits 160 and 162 to create two different trajectories for their respective fluid streams. An example of a ramp 255 is shown in FIGS. 18 and 19. It is contemplated that these different trajectories may result in more uniform fluid distribution about the deflector 114. In some forms, it is contemplated that the arrangement of different channel depths within a channel may reduce rotational speed by introducing more of a vertical component and less of horizonal component at the end of the channel. In some forms, a reduction in the effect of the horizontal component may reduce the overall rotational drive force on the deflector 114.

In one form, it is contemplated that various speed reduction features may be balanced against other factors, such as maximum throw distance and uniformity of fluid distribution. For example, these rotational speed reduction features may include: (1) siphoning water from the first flow channel 156 using a divider wall 159 and a second flow channel 158; and (2) selecting opposing exit directions for the first and second flow channels 156 and 158 such that the second flow channel 158 generates a rotational force in opposition to that of the first flow channel 156. In addition, features may be added to facilitate more uniform fluid distribution, such as, for example, different flow channel depths within a channel at and approaching the exit. Some of these features may have an effect on one or more of speed reduction, maximum throw distance, and uniformity of fluid distribution Each of these foregoing features may be used separately or in combination with one or more to achieve the desired irrigation coverage, including, but not limited to, the desired throw distance, uniformity of watering coverage, and life span for the sprinkler.

In one form, the deflector 114 also includes a plate 164 that acts as a lid to cover the cylindrical recess 134 of the nozzle 112 in the non-operational position. The diameter of this plate 164 is preferably selected so that it is larger than the corresponding diameter of the cylindrical recess 134 of the nozzle 112. When the dual stream spinner assembly 100 is not in operation, the deflector 114 will occupy the lowered position. In this non-operational position, the plate 164 helps protect the nozzle exit orifice 132 from debris, insects, and other particulate matter that might tend to clog the orifice 132.

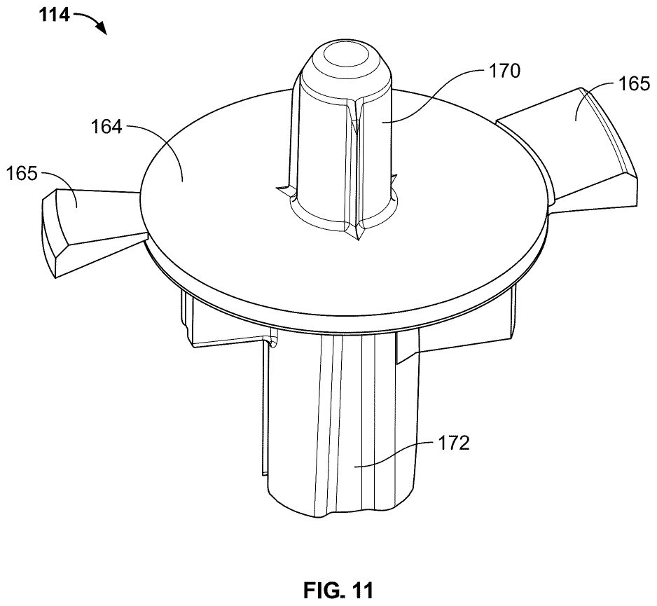

In one form, the deflector 114 may further include one or more removable tabs 165 that extend outwardly from the plate 164. FIGS. 11-13 show two removable tabs 165 that are positioned near the exits 160 and 162 of the two flow channels 156 and 158. The removable tabs 165 are positioned such that the first and second fluid streams exiting the flow channels 156 and 158 may impact them and deflect their trajectory to a closer region about the deflector 114. In other words, the deflector 114 may include at least one of a first removable tab 165 downstream of the first exit 160 disposed to change a first trajectory of fluid exiting the first exit 160 and a second removable tab 165 downstream of the second exit 162 disposed to change a second trajectory of fluid exiting the second exit 162. The removable tabs 165 may be made of a frangible material such that they may be removed to allow for a trajectory to a more distant region from the deflector 114. In another form, a thin-walled section (i.e., a frangible connection) may be at the transition from the plate 164 to each of the tabs 165. This frangible connection is easily severed such as by tearing or cutting to remove the tabs 165. In some forms, the deflector 114 may include one or both removable tabs 165.

In one form, another ceramic body 120 with a ceramic engagement portion 168 is mounted to the deflector 114. In one form (like ceramic body 118), the ceramic body 120 is a ceramic cap that is mounted over a shaft 170 (or cylindrical protrusion) extending upwardly from the deflector 114. In this form, the shaft 170 is the upper end of the deflector 114 that is received in the recess 152 of the frame 116. In some forms, the ceramic body 120 may be composed entirely of a ceramic material. In other forms, only the top portion (which engages ceramic body 118 during rotation of the deflector 114) is composed of a ceramic material. Ceramic material is preferably used because it has been found that ceramic material causes little friction upon rotational engagement with another component, especially upon rotational engagement with other ceramic material. Further, the rotational engagement may have a polishing effect on the ceramic material, which may reduce the friction of this engagement. Over time, this results in less wear on the components and longer life of the dual stream spinner assembly 100.

In one form, as shown in FIG. 4A, the ceramic bodies 118, 120 may be caps facing away from one another with engagement portions 157, 168 that are convex. However, these engagement portions 157, 168 may have different shapes. For example, in one form, the engagement portion 157 may be concave, while engagement portion 168 remains convex. In this form, the concave top cap 118 may allow the bottom convex cap 120 to align and center itself when the deflector 114 is in the operational position. Conversely, in another form, the opposite arrangement is possible in which the upper engagement portion 157 remains convex, while the lower engagement portion 168 is concave. Alternatively, in another form, one or both bodies 118, 120 may be in the shape of a disk with concave and convex surfaces. FIG. 4C shows an alternative form of a deflector 114A in which both bodies 118A, 120A are disks with complementary surfaces opening downward and with generally the same orientation relative to one another.

Further, the bodies 118, 120 in the form of caps may be different sizes. For example, in one form, as shown in FIG. 4D, cap 118B of deflector 114B may be a larger size and may be inverted such that the other cap 120B is received and nested within it. In one form, the cap 118B may be disposed along the inner surface of cylindrical sidewall 150 such that cap 120B is nested within it. In this form, the top cap 118B may be inverted and open downward so as to enclose the wear surfaces at the top of the deflector 114B. In other forms, the cap 118B may replace the cylindrical sidewall 150.

In some forms, the dual stream spinner assembly 100 may include only one cap. For example, the assembly 100 may include an inverted top cap 118 in lieu of the cylindrical sidewall 150 (or disposed along the inner surface of the cylindrical sidewall 150), and the top cap 118 may be composed of a ceramic material. In this form, the shaft 170 may be uncapped and may also be composed of a ceramic material for engagement with the top cap 118.

In another form, as shown in FIG. 4E, it is contemplated that a flow channel 161 may be added through the deflector 114C to provide a water bearing at the top end of the deflector 114C. FIG. 4E shows the deflector 114C in a raised, operational position. As can be seen, a third flow channel 161 extends axially through the deflector 114C, in addition to the first and second flow channels. In one form, as shown in FIG. 4E, there may be no caps, and fluid may impact a concave surface 167 of the frame 116C. In other forms, the deflector may use caps. For example, the flow channel 161 may extend through a body/cap mounted to the top end of the deflector, and a corresponding top body/cap mounted to the frame may have a concave surface. During operation, water flowing through flow channel 161 will exert an axial upward force against the concave surface 167. In this form, it is generally contemplated that adding the flow channel 161 axially through the deflector 114C creates, during operation, a water bearing at the top end that separates the deflector 114C and frame 116C (or that reduces the force of engagement between the deflector 114C and frame 116C), which may reduce wear over time.

Prior to operation, the deflector 114 is in a lowered, non-operational position in which the deflector 114 covers the top of the nozzle 112. In this position, the deflector 114 protects the nozzle 112 from the entry of particulate matter that might clog the nozzle 112. During operation, when water (or fluid) flow is initiated, the deflector 114 is directed upwardly against the frame 116. More specifically, an upper end of the deflector 114 with a ceramic body 120 (such as a cap) is urged upwardly into the recess 152 of the frame 116. In the recess 152, the ceramic body 120 engages a corresponding ceramic body 118 (which may also be in the form of a cap) that may be mounted on a protrusion 154 of the frame 116.

During operation, fluid flows through the first and second flow channels 156 and 158. The exit angles of the first and second flow channels 156 and 158 cause rotation of the deflector 114. Although the fluid streams exiting the flow channels 156 and 158 cause opposing rotational forces, the larger first fluid stream predominates and causes rotation in the direction corresponding to its rotational force. During operation, fluid flows into the inlet 124, through the tapered flow passage 130 of the nozzle 112, out through the exit orifice 132 of the nozzle 112, into the first and second flow channels 156 and 158 of the deflector 114, outwardly from the deflector 114 and is redirected by the one or more removable tabs 165 (if they are present). Following operation, when water flow is discontinued, gravity returns the deflector 114 to its lowered, non-operational position covering the nozzle 112. The lower end 172 of the deflector 114 is received and seated within the annular portion 136 of the nozzle 112.

It is generally contemplated that the height of the deflector 114 is sufficiently long so that the deflector 114 may consistently move between non-operational and operational positions without becoming misaligned. In one form, the lower end 172 (or tail) of the deflector 114 may be lengthened to adjust the amount of movement of the deflector 114 between non-operational and operational positions. In one form, it is contemplated that the lower end 172 may be lengthened so that there is little or no movement of the deflector 114 between non-operational and operational positions. Increasing the length of the lower end 172 may facilitate alignment of the bearing surfaces. In some forms, this “long tail” version may also include a nozzle 112 with a longer annular portion 136 to receive the longer deflector 114. In these forms, it is generally contemplated that, after the deflector 114 rises to its operational position, there is more engagement of the deflector 114 and annular portion 136 that may facilitate alignment of the deflector 114 while it is rotating.

In one form, it is also contemplated that ceramic material may be used at another area of the dual stream spinner assembly 100. As shown in FIG. 4A, when the deflector 114 is in the raised, operational position, its lower end 172 may engage the annular seat 136 of the nozzle 112 during rotation. In one form, ceramic material may be disposed on part or all of the inner surface of the annular seat 136 (at least the top portion) and/or may be disposed on part or all of the outer surface of the lower end 172 of the deflector 114 (at least near the bottom of the lower end 172). In other words, the seat 136 may include a ceramic portion for engagement with the deflector 114 when the deflector 114 is rotating in the operational position, and/or the lower end 172 of the deflector 114 may include a ceramic portion for engagement with the seat 136 when the deflector 114 is rotating in the operational position.

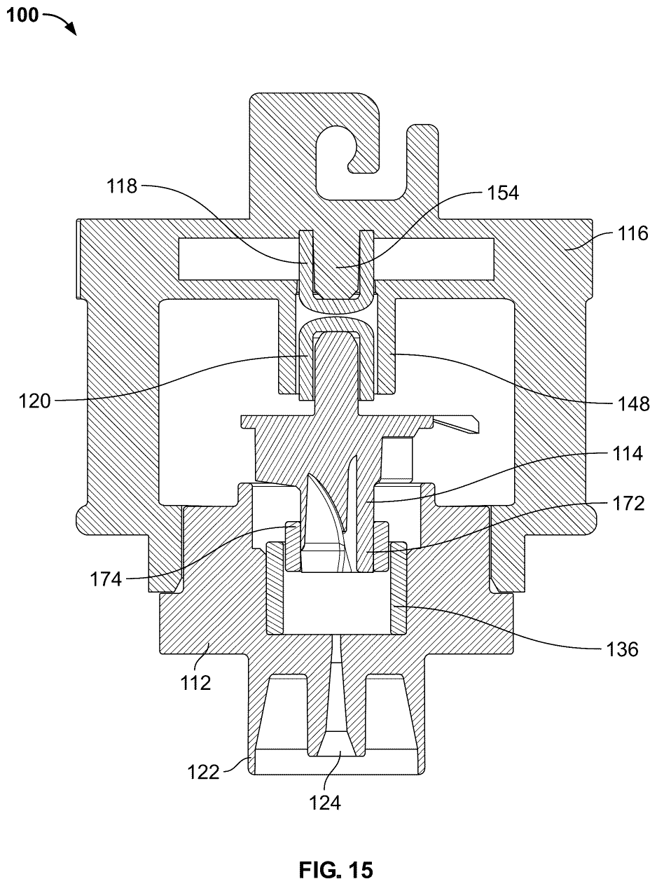

FIG. 15 shows an example of ceramic material disposed at a lower end 172 of the deflector 114. In this form, a ceramic collar 174 (or ring) is disposed about the lower end 172 of the deflector 114. Further, in this form, the annular seat 136, which is also in the shape of an annular collar or ring, may be formed of ceramic. During rotation, the outer surface of the ceramic collar 174 engages the inner surface of the ceramic annular seat 136. It is also contemplated that, in some forms, the deflector 114 may use just one of these ceramic elements and does not necessarily include both. Also, in some forms, it is contemplated that just the top portion of the annular seat 136 includes ceramic material, not the entire annular seat 136. Further, in some forms, it is contemplated that the entire deflector 114 may be formed of a ceramic material, which would then not require the use of a ceramic cap/body 120 at the top end and a ceramic collar 174 at the bottom end.

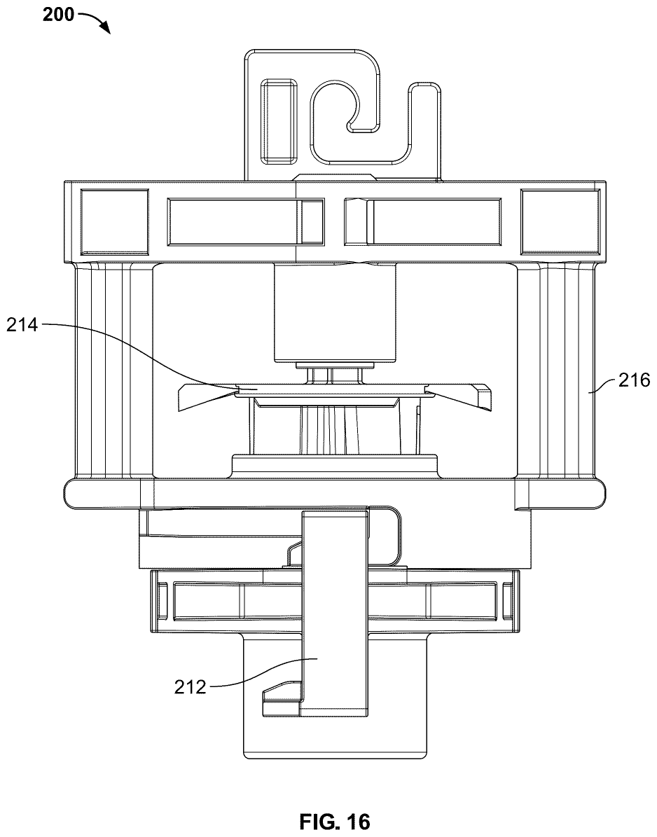

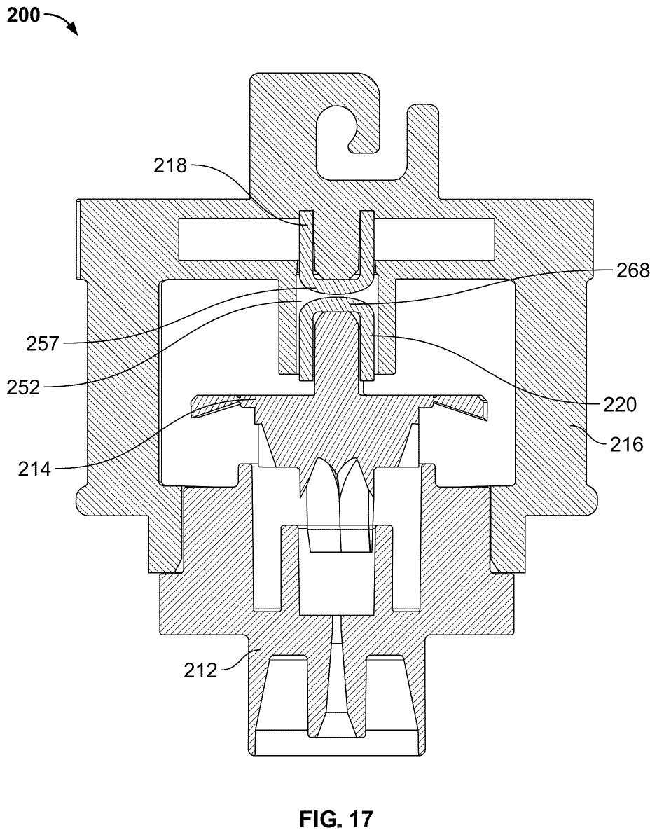

FIGS. 16-17 show a second embodiment of a dual stream spinner assembly 200 with the deflector 214 in a raised, operational position. The dual stream spinner assembly 200 includes most of the same components as the first embodiment, and corresponding reference numerals have been used (in the 200s). The dual stream spinner assembly 200 includes a nozzle 212, a deflector 214, a frame 216, and two ceramic bodies 218 and 220 in the form of ceramic caps. The description above regarding the structure and operation of the components of the first embodiment applies generally to the corresponding components of dual stream spinner assembly 100, except as addressed below.

In this form, the first and second flow channels 256 and 258 have first and second exits 260 and 262 that are oriented so as not to oppose one another. In other words, the first and second exits 260 and 262 are oriented so that each of the first and second fluid streams leaving each respective exit generates a rotational force that is in the same circumferential direction as the other fluid stream. In this form, there is no counter-rotational force. Further, in this form, the first and second flow channels 256 and 258 generally are of about equal size with generally the same cross-sectional area.

As shown in FIG. 18, in this form, given the generally equal sized flow channels 256 and 258, the divider wall 259 is not offset from the central axis C of the deflector 214 and intersects the central axis C. It is generally contemplated that both flow channels 256 and 258 will have substantially the same size entrance area, or inlet, to receive fluid. The general curvature of the two flow channels 256 and 258 may be selected for the desired fluid distribution characteristics, such as throw distance and irrigation coverage. In this form, both flow channels 256 and 258 have a curved flow channel to achieve a long throw distance. It should be understood, however, that either flow channel 156 and 158 may have any desired amount of curvature, as may be appropriate for certain circumstances. It is also contemplated that the exit angles are in the range of about 25-35 degrees, but it is also contemplated that other exit angles may also be used.

FIGS. 18 and 19 are views of the deflector 214 and show the exit 260 of the first flow channel 256. As can be seen, the first flow channel 256 includes a ramp 255 approaching the exit 260 that defines two different depths of the first flow channel 256. In one form, the ramp 255 may be positioned at the inside of the curve such that the depth of the first flow channel 256 at the inside of the curve is less than the depth of the first flow channel 256 at the outside of the curve. This ramp 255 subdivides the exiting fluid stream into two different sub-streams having different vertical components. In this form, the fluid stream at the outside of the curve, as it approaches the exit 260 of the channel 256, may have a greater vertical force component and a reduced horizontal force component relative to the channel 256 without the ramp 255.

In this form, the first and second flow channels 256 and 258 may generally have the same curvature and exit angles, although they may not in other forms. Thus, in the one form, the deflector 214 includes a first flow channel 256 for a first fluid stream with a first exit and a second flow channel 258 for a second fluid stream with a second exit, the first and second exits oriented such that the first and second fluid streams exiting the deflector 214 cause a combined rotational force on the deflector 214. In FIGS. 16-19, this combined rotational force results from the first and second fluid streams causing supporting rotational forces in the same direction, although, in other forms, they may cause opposing rotational forces, such as discussed above for the earlier embodiment.

In this form, it is generally contemplated that the dual stream spinner assembly 200 includes, at least, two ceramic bodies 218 and 220. As in the first embodiment, in one form, the first ceramic body 218 is mounted to the frame 216 with a first ceramic engagement portion 257, and the second ceramic body 220 is mounted to the deflector 214 with a second ceramic engagement portion 268. In some forms, the ceramic bodies 218 and 220 may be composed entirely of a ceramic material, but in other forms, only the engagement portions 257 and 268 are composed of a ceramic material. However, in other forms, it is contemplated that the entire deflector 214 may be formed of a ceramic material, which would then not require the use of a separate ceramic cap/body 220 at the top end of the deflector 214 or a separate ceramic body at the bottom end of the deflector 214.

In one form, the frame 216 includes a recess 252 for receiving and retaining an end of the deflector 214 when the deflector is in the operational position. The first body 218 with the first ceramic engagement portion 257 may be in the form of a first cylindrical cap mounted to the frame 216. Similarly, the second body 220 with a second ceramic engagement portion 268 may be in the form of a second cylindrical cap mounted to the end of the deflector 214. Thus, in this form, the dual stream spinner assembly 200 includes first and second flow channels 256 and 258 that create supporting rotational forces and also includes two ceramic bodies 218 and 220 that engage one another during rotation of the deflector 214. In this form, it may be determined that counter-rotational forces are not desired.

Although this disclosure addresses the use of ceramic material to provide low friction engagement surfaces, it is also contemplated that certain other types of materials may be used for certain components. It is generally desirable to use materials that have a low wear factor K, which provides a measure of a material's resistance to wear. The wear factor K may be calculated according to the following formula: K=W/(F*V*T), where W is the wear volume (volume of material lost) (in³), F is the force acting on the material (lb), V is the velocity at the wear interface (ft/min), and T is time (hr). The wear factor K may also be calculated in metric units where W is the wear volume (volume of material lost) (m³), F is the force acting on the material (N), V is the velocity at the wear interface (m/sec), and T is time (sec). In one form, it may be desirable to use materials with a K that is under 100 (in³-min/ft-lb-hr)10⁻¹⁰ (or under 200 (mm³/N-m)10⁻⁸), but the recitation of wear factors in this disclosure is not intended to limit the use of the materials disclosed herein.

For example, in one form, it is contemplated that all or part of the deflectors disclosed herein may be made from isoplast, polyoxymethylene (POM), nylon, urethane, polyurethane, or rigid thermoplastic polyurethane materials. In some forms, the wear factor for POM materials may be under 60 (in³-min/ft-lb-hr)10⁻¹⁰ (or under 120 (mm³/N-m)10⁻⁸), and for nylons, it may be under 50 (in³-min/ft-lb-hr)10⁻¹⁰ (or under 100 (mm³/N-m)10⁻⁸. In one form, a deflector composed of these materials need not include a cap/body mounted to the top of the deflector. It is contemplated that these materials may constitute low friction materials with good toughness and wear resistance that would be desirable for rotating deflectors.

As another example, in one form, it is contemplated that part or all of the bodies/caps disclosed herein and mounted at the top ends of the deflectors may be formed of a high-density polyethylene (HDPE) material. Further, in one form, part or all of the corresponding bodies/caps disclosed herein and mounted to the frame may also be formed of HDPE. Also, the collar disclosed herein and mounted at the lower end of the deflector may be formed of HDPE. HDPE may have a low wear rate, which makes it suitable for acting as engagement surfaces of the rotating deflector and the frame. In one form, the HDPE wear rate may be under 30 (in³-min/ft-lb-hr)10⁻¹⁰ (or under 60 (mm³/N-m)10⁻⁸.

As an additional example, in one form, it is contemplated that part or all of the deflectors, the bodies/caps mounted at the top ends of the deflectors, the corresponding bodies/caps mounted to the frame, and/or the collar mounted at the lower end of the deflector may be formed of anodized aluminum. Anodized aluminum involves an electrochemical process that creates an oxide layer on the aluminum surface that increases its resistance to wear. The anodized aluminum is preferably hard so as to have a low wear rate.

It will be understood that various changes in the details, materials, and arrangements of parts and components which have been herein described and illustrated to explain the nature of the spinner assemblies may be made by those skilled in the art within the principle and scope of the spinner assemblies as expressed in the appended claims. Furthermore, while various features have been described regarding a particular embodiment or a particular approach, it will be appreciated that features described for one embodiment also may be incorporated with the other described embodiments.

What is claimed is:

1. An irrigation device comprising:
a base comprising a fluid inlet;
a flow path extending from the fluid inlet;
a divider along the flow path to separate flow into a first flow and a second flow;
a frame engaging and extending across the base; and
a deflector having a first side supported by the base, a second side supported by the frame, a first flow channel positioned to receive the first flow to form a first fluid stream oriented to generate a first rotational force, and a second flow channel positioned to receive the second flow to form a second fluid stream, and the deflector continuously rotating when subjected to fluid from a fluid source.

2. The irrigation device of claim 1, wherein the second flow channel is shaped to provide the second fluid stream with a neutral effect on the first rotational force.

3. The irrigation device of claim 1, wherein the second flow channel is shaped to provide the second fluid stream with a second rotational force to oppose at least in part the first rotational force, wherein the first rotational force is greater than the second rotational force.

4. The irrigation device of claim 1, wherein the first flow channel includes a first exit and an arcuate portion leading to the first exit.

5. The irrigation device of claim 4, wherein the second flow channel includes a second exit and is entirely linear with an angled surface at the second exit.

6. The irrigation device of claim 1, wherein the frame comprises a recess shaped to house a portion of the first side of the deflector.

7. The irrigation device of claim 6, comprising a first ceramic surface at the recess.

8. The irrigation device of claim 7, comprising a second ceramic surface at the deflector, the first ceramic surface and the second ceramic surface engaging when the deflector is rotating.

9. The irrigation device of claim 1, wherein the base comprises a seat shaped to house a portion of the second side of the deflector.

10. The irrigation device of claim 9, wherein the seat includes a first ceramic surface for engagement with the deflector when the deflector is rotating.

11. The irrigation device of claim 10, wherein the portion of the second side of the deflector includes a second ceramic surface for engagement with a first ceramic surface when the deflector is rotating.

12. The irrigation device of claim 1, comprising at least one of a first removable tab downstream of the first flow channel to change a first trajectory of fluid exiting the first flow channel and a second removable tab downstream of the second flow channel to change a second trajectory of fluid exiting the second flow channel.

13. The irrigation device of claim 1, wherein at least one of the first flow channel and the second flow channel includes at least two different channel depths along at least a portion thereof to create two different trajectories for fluid exiting therefrom.

14. The irrigation device of claim 1, wherein the deflector is configured to move between an operational position where the deflector is positioned a first distance from the fluid inlet and a non-operational position where the deflector is positioned a second distance from the fluid inlet, the first distance being greater than the second distance.

15. The irrigation device of claim 1, wherein the base comprises a flow passage extending from the fluid inlet and wherein the deflector comprises the divider positioned to separate fluid into the first flow and the second flow after exiting the flow passage.

16. The irrigation device of claim 1, wherein the frame comprises at least one strut disposed in a path of fluid exiting the deflector as the deflector rotates, the at least one strut comprising an apex pointed in a direction at an angle relative to an axis of deflector rotation.

17. A deflector for an irrigation device comprising:
a first side including a first rotating engagement surface extending therefrom; and
a second side including:
a first flow channel for a first fluid stream with a first exit oriented to generate a first rotational force acting on the deflector;
a second flow channel for a second fluid stream with a second exit oriented either to generate no rotational force or a second rotational force opposing the first rotational force; and
a second rotating engagement surface extending therefrom and terminating upstream of the first exit and the second exit.

18. The deflector of claim 17, wherein at least one of the first rotating engagement surface and the second rotating engagement surface includes a reduced friction bearing surface.

19. An irrigation device comprising:
a fluid inlet configured to receive fluid from a fluid source;
a nozzle in fluid communication with the fluid inlet and comprising a flow passage;
a frame engaging and extending across the nozzle;
a first ceramic surface associated with the frame or nozzle;
a deflector having a first side supported by the nozzle and a second side supported by the frame, the deflector continuously rotating when subjected to fluid from the nozzle; and
a second ceramic surface associated with the deflector,
wherein the deflector is movable between an operational position, in which the frame engages the deflector and the first ceramic surface and the second ceramic surface engaging during rotation, and a non-operational position where the deflector seats on the nozzle.

20. The irrigation device of claim 19, wherein the frame defines a recess for retaining a portion of the second side of the deflector.

21. The irrigation device of claim 20, wherein the first ceramic surface is on a first cylindrical cap mounted to the frame.

22. The irrigation device of claim 21, wherein the second ceramic surface comprises a second cylindrical cap mounted to the portion of the second side of the deflector.

23. The irrigation device of claim 19, wherein the deflector defines a first flow channel arranged to generate a first rotational force and a second flow channel arranged to generate a second rotational force, the second rotational force opposing at least in part the first rotational force.

24. The irrigation device of claim 19 wherein the deflector is entirely formed of a ceramic material.
